(19) United States
(12) Patent Application Publication
(10) Pub. No.: US 2022/0106970 A1
(43) Pub. Date: Apr. 7, 2022

(54) CLAMPING APPARATUS

(71) Applicant: COMLOCK ENTERPRISE CO., LTD., TAICHUNG (TW)

(72) Inventor: NIAN-HAO LIAO, TAICHUNG (TW)

(21) Appl. No.: 17/376,166

(22) Filed: Jul. 15, 2021

(30) Foreign Application Priority Data
Oct. 6, 2020 (TW) 109213126

(51) Int. Cl. F16B 2/04; F16B 7/04

(52) U.S. Cl. CPC F16B 2/04; F16B 7/0413

(57) ABSTRACT

A clamping apparatus includes a handle, two claws, a joint and a spring. The handle is pivotally connected to a portion of the joint. The claws are pivotally connected to another portion of the joint. The spring is located between the claws so that the spring biases the claws from each other.

### BACKGROUND OF INVENTION

### 1. Field of Invention

The present invention relates to a coupling mechanism for interconnecting two objects and, more particularly, to a clamping apparatus operable to disable a coupling mechanism.

### 2. Related Prior Art

Referring to FIG. 5, there is shown a coupling mechanism 80 for interconnecting two electric wires (not shown). For example, the coupling mechanism 80 includes a plug 82 and a socket 84. The plug 82 is connected to one of the electric wires. The socket 84 is connected to the remaining one of the electric wires. The electric wires are connected to each other by engaging the plug 82 with the socket 84.

Typically, the socket 84 includes two hooks 83. Each of the hooks 83 includes a barb 81. The plug 82 includes two cavities 85 in communication with two apertures 87. When the socket 84 is electrically engaged with the plug 82, the hooks 83 of the socket 84 are inserted in the cavities 85 of the plug 82 and the barbs 81 of the socket 84 are inserted in the apertures 87 of the plug 82, thereby keeping the socket 84 electrically engaged with the plug 82. To electrically disengage the socket 84 from the plug 82, the hooks 83 are pressed and hence pivoted toward the socket 84 to move the barbs 81 from the apertures 87, thereby allowing disengagement of the socket 84 from the plug 82.

However, fungus, bacteria and or virus is inevitably transferred to a user's hand from the coupling mechanism 80 during the operation. Hence, hygiene is not taken care of during the operation.

The present invention is intended to obviate or at least alleviate the problems encountered in the prior art.

### SUMMARY OF INVENTION

It is the primary objective of the present invention to provide a clamping apparatus for allowing a user to disengaging a plug from a socket without having to contact with the plug or the socket with bare hands.

To achieve the foregoing objective, the coupler-clamping apparatus includes a handle, two claws, a joint and a spring. The handle is pivotally connected to a portion of the joint. The claws are pivotally connected to another portion of the joint. The spring is located between the claws so that the spring biases the claws from each other.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is an exploded view of a clamping apparatus according to the first embodiment of the present invention;

FIG. 2 is an enlarged partial view of a claw of the clamping apparatus shown in FIG. 1;

FIG. 3 is a perspective view of the clamping apparatus shown in FIG. 1;

FIG. 4 is a perspective view of the clamping apparatus in another position than shown in FIG. 3;

FIG. 5 is a cross-sectional view of a conventional coupling mechanism and the clamping apparatus shown in FIG. 3;

FIG. 6 is an enlarged partial view of the clamping apparatus shown in FIG. 5;

FIG. 7 is a perspective view of a clamping apparatus according to the second embodiment of the present invention; and

FIG. 8 is a perspective view of the clamping apparatus in another position than shown in FIG. 7.

### DETAILED DESCRIPTION OF EMBODIMENTS

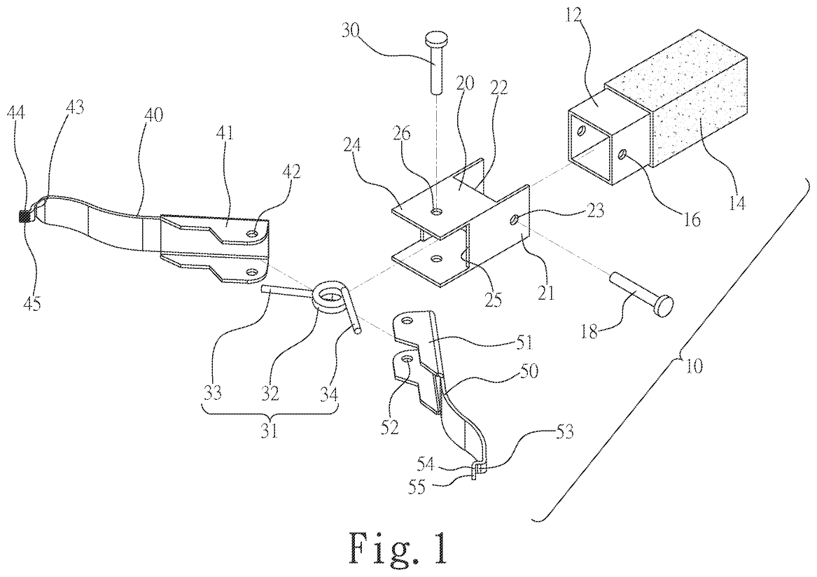

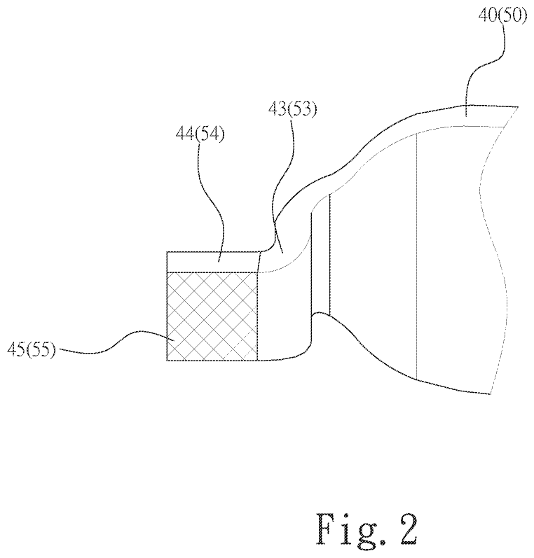

Referring to FIGS. 1 through 3, a clamping apparatus 10 includes a handle 12, a joint 20, a spring 31, two claws 40 and 50 and two pivots 18 and 30 according to the preferred embodiment of the present invention. The handle 12 is a square tube formed with two opposite apertures 16. The handle 12 is coated with a protective layer 14 that does not cover the apertures 16. The protective layer 14 is made by injection molding of a non-metal material such as plastics.

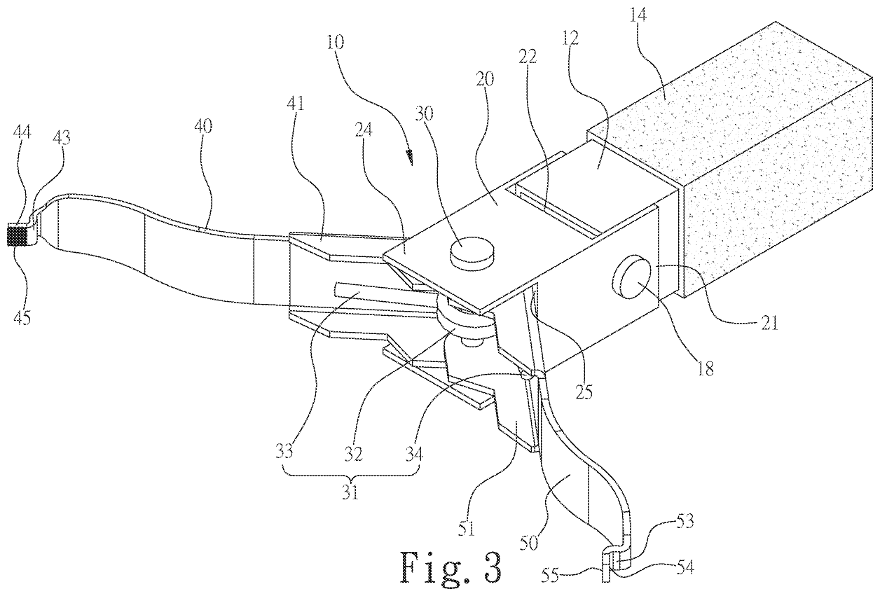

The joint 20 is a square tube including two plates 21 extending parallel to each other, two parallel plates 24 extending perpendicular to the plates 21, and two opposite open ends 22 and 25. Each of the plates 21 includes an aperture 23 in an extensive portion extending beyond the plates 24 adjacent to the open end 22. Each of the plates 24 includes an aperture 26 in an extensive portion extending beyond the plates 21 adjacent to the open end 25. The handle 12 is located between the plates 21 before the pivot 18 is inserted in the apertures 16 and 23 to pivotally connect the handle 12 to the joint 20 (FIG. 3).

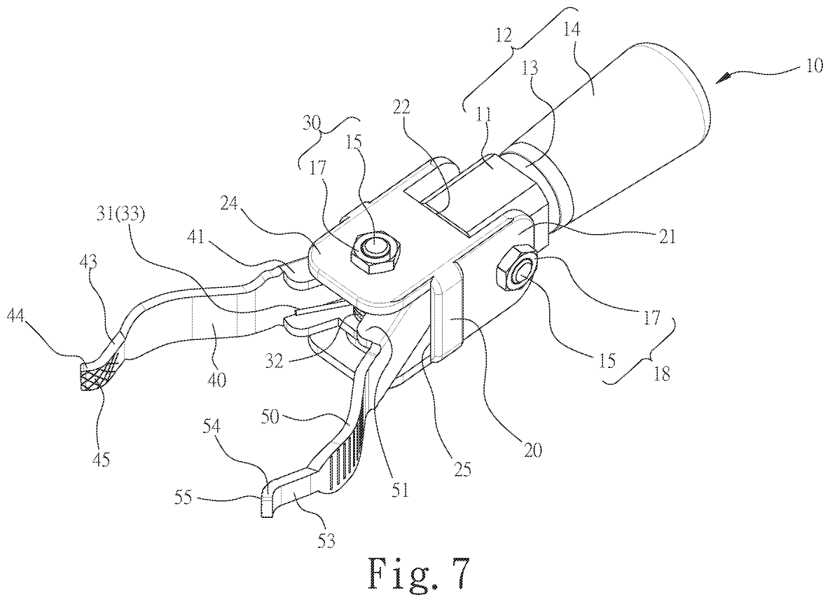

The pivots 18 and 30 are rivets in the preferred embodiment referring to FIG. 1. Each of the pivots 18 and 30 can be a combination of a threaded bolt 15 with a nut 17 in another embodiment referring to FIG. 7.

The spring 31 is torque spring including a helical portion 32 formed between two rectilinear portions 33 and 34 in the preferred embodiment. However, the spring can be a compression spring, a leaf spring, a coil spring, a helical spring or any other proper spring.

The claws 40 and 50 are identical to each other in structure but different in position. The claw 40 includes two lugs 41 at an end, a contact portion 44 at another end, and a curved portion 43 adjacent to the contact portion 44. Each of the lugs 41 includes an aperture 42. The apertures 42 are aligned to each other. The curved portion 43 is used to render the contact portion 44 in a desired position. The contact portion 44 is formed with an anti-skid face 45.

The anti-skid face 45 includes two groups of grooves that intersect each other in the preferred embodiment. However, the anti-skid face 45 can include bosses in another embodiment. The anti-skid face 45 is formed on the contact portion 44 in the preferred embodiment. However, the anti-skid face 45 can be formed on a pad attached to the contact portion 44.

Similarly, the claw 50 includes two lugs 51 at an end, a contact portion 54 at another end, and a curved portion 53 adjacent to the contact portion 54. Each of the lugs 51 includes an aperture 52. The apertures 52 are aligned to each other. The curved portion 53 is used to render the contact portion 54 in a desired position. The anti-skid face 55 is formed on the contact portion 54 in the preferred embodiment. However, the anti-skid face 55 can be formed on a pad attached to the contact portion 54.

The anti-skid face 55 includes two groups of grooves that intersect each other in the preferred embodiment. However, the anti-skid face 55 can include bosses in another embodiment. The anti-skid face 55 is formed on the contact portion 54 in the preferred embodiment. However, the anti-skid face 55 can be formed on a pad attached to the contact portion 54.

Referring to FIG. 3, each of the lugs 41 is in contact with one of the lugs 51. The lugs 41 are located between the lugs 51, or the lugs 51 are located between the lugs 41, or each of the lugs 41 is located on or beneath one of the lugs 51. Then, the lugs 41 and 51 of the claws 40 and 50 are located between the extensive portions of the plates 24. In addition, the spring 31 is located between the claws 40 and 50. The helical portion 32 of the spring 31 is located between the lugs 41, or between the lugs 51, or between one of the lugs 41 and one of the lugs 51. Then, the pivot 30 is inserted in the apertures 26 of the plates 24 of the joint 20, the apertures 42 of the lugs 41 of the claw 40, the apertures 52 of the lugs 51 of the claw 50 and the helical portion 32 of the spring 31. The rectilinear portion 33 of the spring 31 is in contact with an internal face of the claw 40. The rectilinear portion 34 of the spring 31 is in contact with an internal face of the claw 50. Thus, the spring 31 tends to open the claws 40 and 50, i.e., pivot them from each other. The opening of the claws 40 and 50 is limited to an angle smaller than 180 degree because each of them is abutted against an edge of each of the plates 21 at the open end 25 of the joint 20.

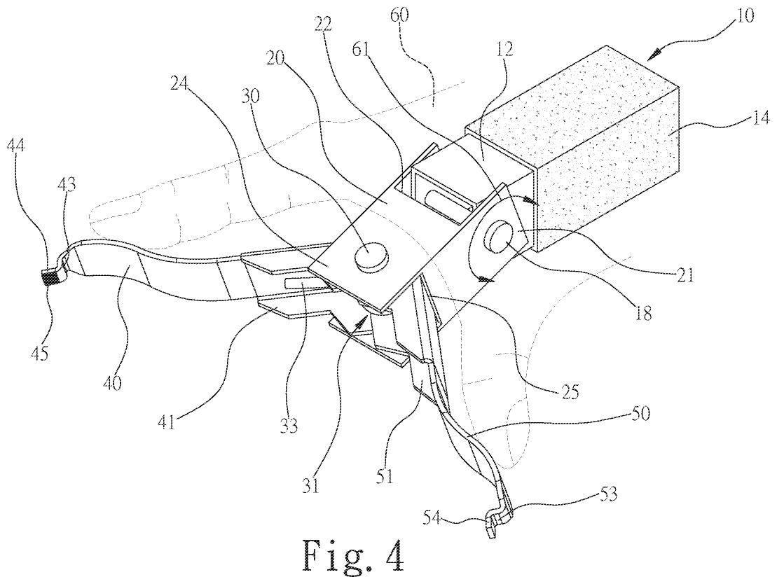

Referring to FIG. 4, a user operates the clamping apparatus 10 with a hand 60. The pawl is in contact with the protective layer 14 coated on the handle 12. The index finger is in contact with an external face of the claw 40. The thumb is in contact with an external face of the claw 50. The user pivots the joint 20 relative to the handle 12 about the pin 18 as indicated by arrow heads 61, i.e., render the clamping apparatus 10 in a shape to fit the hand 60 so that the user feels comfortable in the hand 60 while operating the clamping apparatus 10.

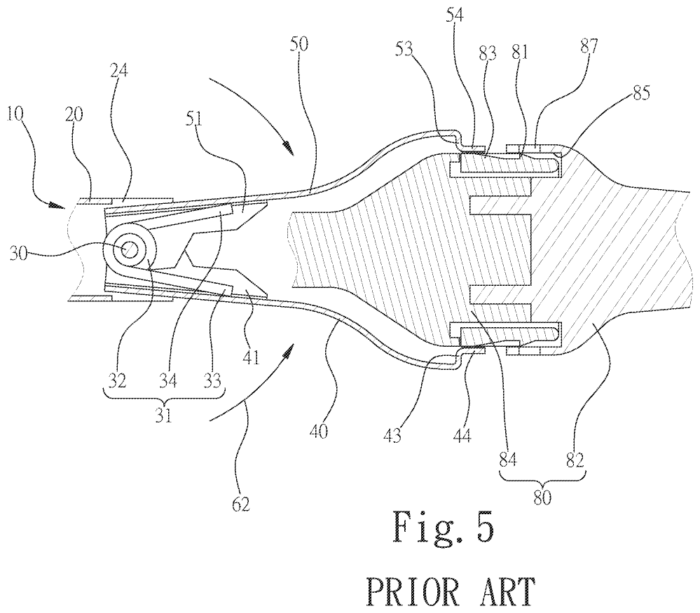

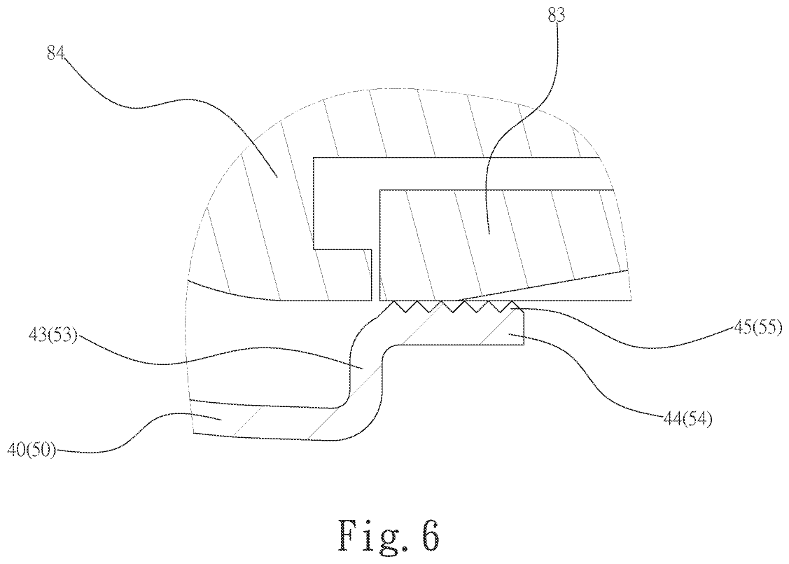

Referring to FIGS. 5 and 6, the user pivots the claws 40 and 50 toward each other about the pivot 30 as indicated by arrow heads 62 with the index finger and the thumb. Thus, the user brings the anti-skid faces 45 and 55 of the contact portions 44 and 54 of the claws 40 and 50 toward each other. The anti-skid faces 45 and 55 of the contact portions 44 and 54 of the claws 40 and 50 are brought into contact with the hooks 83 to move the barbs 81 from the apertures 87. Thus, disengagement of the plug 82 from the socket 84 is allowed. The anti-skid faces 45 of 55 of the contact portions 44 and 54 of the claws 40 and 50 facilitate firm contact of the claws 40 and 50 with the hooks 83 to avoid slipping of the socket 84 from the claws 40 and 50 while using the clamping apparatus 10 to disengage the socket 84 from the plug 82.

With the clamping apparatus 10, the user is allowed to disengage the plug 82 from the socket 84 without having to contact any of them with bare hands 60. Hence, fungus, bacteria and or virus cannot be transferred to the hand 60 from the coupling mechanism 80 during the operation. Thus, the operation is completed and hygiene is taken care of

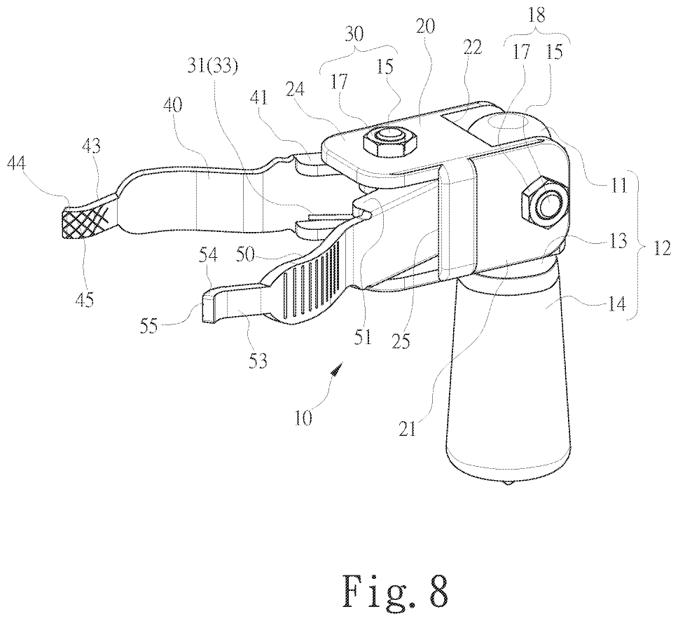

Referring to FIGS. 7 and 8, there is shown a clamping apparatus 10 according to a second embodiment of the present invention. The second embodiment is like the first embodiment except for several things. Firstly, a combination of a threaded bolt 15 with a nut 17 is used instead of each of the pivots 18 and 30.

Secondly, the handle 12 includes a polygonal portion 11 made in one piece with a frustoconical portion 13. The polygonal portion 11 of the handle 12 is located between the plates 21 and the threaded bolt 15 is inserted in the plates 21 and the polygonal portion 11 of the handle 12, thereby pivotally connecting the joint 20 to the handle 12. The protective layer 14 is coated on the frustoconical portion 13 of the handle 12.

Thirdly, the external face of each of the claws 40 and 50 is an anti-skid face to increase friction with the index finger or the thumb. Thus, the handling of the clamping apparatus 10 with the hand 60 is rendered firm.

Fourthly, the claws 40 and 50 are in another shape.

The present invention has been described via the illustration of the embodiments. Those skilled in the art can derive variations from the embodiments without departing from the scope of the present invention. Therefore, the embodiments shall not limit the scope of the present invention defined in the claims.

1. A clamping apparatus comprising:
a joint comprising a first portion and a second portion;
a handle pivotally connected to the first portion of the joint;
two claws pivotally connected to the second portion of the joint; and
a spring located between the claws so that the spring biases the claws from each other.

2. The clamping apparatus according to claim 1, further comprising a protective layer coated on the handle.

3. The clamping apparatus according to claim 1, wherein the joint comprises two plates on the first portion, wherein the handle comprises a portion located between and connected to the plates.

4. The clamping apparatus according to claim 3, further comprising a pivot inserted in the plates and the handle.

5. The clamping apparatus according to claim 4, wherein the pivot is selected from the group consisting of a rivet and a threaded bolt.

6. The clamping apparatus according to claim 1, wherein the joint comprises two plates on the second portion, wherein each of the claws comprises a portion located between and connected to the plates.

7. The clamping apparatus according to claim 6, further comprising a pivot inserted in the plates and the claws.

8. The clamping apparatus according to claim 7, wherein the pivot is selected from the group consisting of a rivet and a threaded bolt.

9. The clamping apparatus according to claim 7, wherein the spring comprises:
a helical portion extending around the pivot; and
two rectilinear portions each of which is in contact with one of the claws.

10. The clamping apparatus according to claim 6, wherein each of the claws comprises two lugs located between and connected to the two plates.

11. The clamping apparatus according to claim 10, further comprising a pivot inserted in the plates and the claws.

12. The clamping apparatus according to claim 11, wherein the pivot is selected from the group consisting of a rivet and a threaded bolt.

13. The clamping apparatus according to claim 1, wherein each of the claws comprises:
an end pivotally connected to the joint;
another end formed with a contact portion; and
a curved portion formed between the ends of each of the claws.

14. The clamping apparatus according to claim 13, wherein each of the claws comprises an anti-skid face on the contact portion.

15. The clamping apparatus according to claim 14, wherein the anti-skid face comprises two groups of grooves intersecting each other.
